(19) United States
(12) Patent Application Publication
(10) Pub. No.: US 2024/0162844 A1
(43) Pub. Date: May 16, 2024

(54) MOTOR DRIVING SYSTEM

(71) Applicant: FANUC CORPORATION, Yamanashi (JP)

(72) Inventors: Eijun MURAI, Yamanashi-ken (JP); Shinichi HORIKOSHI, Yamanashi-ken (JP)

(21) Appl. No.: 18/548,592

(22) PCT Filed: Mar. 3, 2022
(86) PCT No.: PCT/JP2022/009070

§ 371 Date: Sep. 1, 2023

(30) Foreign Application Priority Data
Mar. 10, 2021 (JP) 2021-038164

(51) Int. Cl. H02P 27/06

(52) U.S. Cl. CPC H02P 27/06

(57) ABSTRACT

A motor driving system of one embodiment includes a portable apparatus that stores a pairing-use identifier: which is for pairing a converter device and an inverter device; in which a first identifier retained by the converter device was copied; and which can be read by the inverter device.

### TECHNICAL FIELD

The present invention relates to a motor driving system.

### BACKGROUND ART

JP 2018-164377 A discloses a motor driving device including a converter device and an inverter device connected to the converter device.

### SUMMARY OF THE INVENTION

In order to connect the converter device and the inverter device with each other, the pairing processing for pairing the converter device and the inverter device may be required. In this case, an operator is required to operate both the converter device and the inverter device according to a plurality of pairing procedures. For this reason, there is a demand for improving usability in pairing a converter device and an inverter device.

Accordingly, it is an object of the present invention to provide a motor driving system capable of improving usability.

An aspect of the present invention is a motor driving system for pairing a converter device and an inverter device, including a portable apparatus configured to store, for pairing the converter device and the inverter device, a pairing identifier that is a duplicate of a first identifier held by one device out of the converter device and the inverter device and is readable for another device out of the converter device and the inverter device.

According to an aspect of the present invention, the other device can recognize the first identifier of the one device by reading the pairing identifier of the portable apparatus. Therefore, the pairing can be completed without requiring an operator to perform a special operation for pairing up with the other device using an operation manual or the like. As a result, usability can be improved.

### BRIEF DESCRIPTION OF DRAWINGS

FIG. 1 is a block diagram showing a motor driving system of an embodiment;

FIG. 2 is a block diagram showing a motor driving system of modified example 1;

FIG. 3 is a block diagram showing a motor driving system of modified example 2; and

FIG. 4 is a block diagram showing a motor driving system of modified example 3.

### DETAILED DESCRIPTION OF THE INVENTION

### Embodiment

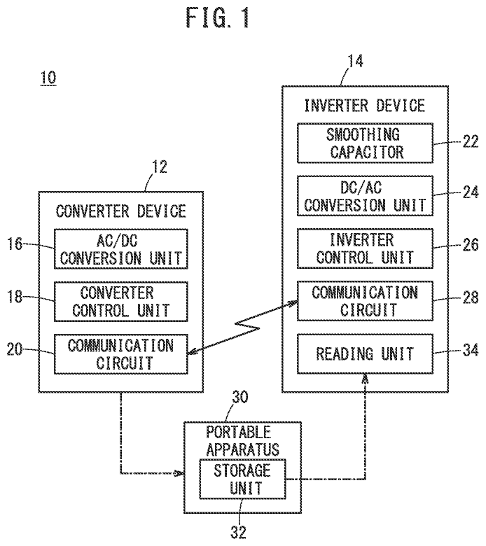

FIG. 1 is a block diagram showing a motor driving system 10 according to an embodiment. The motor driving system 10 includes a converter device 12 and an inverter device 14. The converter device 12 and the inverter device 14 are connected so as to be able to exchange information with each other by performing pairing processing. In the motor driving system 10 of the present embodiment, the converter device 12 is set as a master of pairing, and the inverter device 14 is set as a slave of pairing.

The converter device 12 includes an AC/DC conversion unit 16, a converter control unit 18, and a communication circuit 20. The AC/DC conversion unit 16 converts AC power supplied from the outside into DC power. The converter control unit 18 performs switching control for the AC/DC conversion unit 16.

The inverter device 14 includes a smoothing capacitor 22, a DC/AC conversion unit 24, an inverter control unit 26, and a communication circuit 28. The smoothing capacitor 22 smooths the DC power outputted by the AC/DC conversion unit 16. The DC/AC conversion unit 24 converts the smoothed DC power into AC power. The inverter control unit 26 performs switching control for the DC/AC conversion unit 24. The inverter device 14 drives a motor by outputting, as drive power for the motor, AC power converted by the DC/AC conversion unit 24. The smoothing capacitor 22 may be mounted on the converter device 12 instead of the inverter device 14.

The communication circuit 20 of the converter device 12 and the communication circuit 28 of the inverter device 14 are connected by wire or wirelessly, and information relating to pairing is exchanged via the connected wire or wirelessly. The wire may be a metal cable or an optical cable.

The motor driving system 10 of the present embodiment further includes a portable apparatus 30 in addition to the converter device 12 and the inverter device 14. The portable apparatus 30 is a device that can be carried by an operator. Examples of the portable apparatus 30 are a portable semiconductor memory, an IC tag, a card with code, and suchlike. A specific example of the portable semiconductor memory is a USB memory and suchlike.

The portable apparatus 30 includes a storage unit 32. The storage unit 32 stores a pairing identifier. For example, when the portable apparatus 30 is a portable semiconductor memory or an IC tag, data of the pairing identifier is stored in the memory. When the portable apparatus 30 is a card with code, the code of the pairing identifier is attached to a surface of the card. The pairing identifier is an identifier obtained by duplicating the first identifier held by the converter device 12 in order for the converter device 12 and the inverter device 14 to perform pairing processing.

Further, in the motor driving system 10 of the present embodiment, the inverter device 14 is provided with a reading unit 34 for reading the pairing identifier stored in the portable apparatus 30. For example, when the portable apparatus 30 is a portable semiconductor memory, a memory interface may be used as the reading unit 34. The memory interface has a port to and from which a portable semiconductor memory can be attached and detached, and reads data of the pairing identifier from the storage unit 32 of the semiconductor memory attached to the port. When the portable apparatus 30 is an IC tag, an IC tag reader may be used as the reading unit 34, and when the portable apparatus 30 is a card with code, a code reader may be used as the reading unit 34.

When having read the pairing identifier from the portable apparatus 30, the reading unit 34 registers the pairing identifier. In this case, the communication circuit 28 of the inverter device 14 uses access information of the converter device 12 registered in advance to transmit the second identifier held by the inverter device 14 to the converter device 12 together with the pairing identifier.

When the communication circuit 20 of the converter device 12 receives the second identifier together with the pairing identifier, the communication circuit 20 recognizes that the inverter device 14 that transmitted the second identifier is a regular pairing partner, and registers the second identifier. In this case, the communication circuit 20 communicates with the communication circuit 28.

When the communication circuit 20 of the converter device 12 receives only the second identifier, the communication circuit 20 recognizes that the device transmitting the second identifier is an irregular pairing partner and may discard the second identifier. In this case, the communication circuit 20 rejects the communication with the communication circuit 28.

As described above, the motor driving system 10 of the present embodiment is provided with the portable apparatus 30 separately from the converter device 12, which is the master of pairing, and the inverter device 14, which is the slave of pairing. The portable apparatus 30 stores the first identifier of the converter device 12 as a pairing identifier readable for the inverter device 14. Thus, the inverter device 14 can recognize the first identifier of the converter device 12 by reading the pairing identifier of the portable apparatus 30. Therefore, the pairing identifier of the converter device 12 can be registered in the inverter device 14 without forcing the operator to perform a special operation related to the pairing using an operation manual or the like. As a result, usability can be improved.

Further, in the motor driving system 10 of the present embodiment, the inverter device 14 has the communication circuit 28 that communicates with the converter device 12 by wire or wirelessly. The communication circuit 28 transmits the pairing identifier and the second identifier of the inverter device 14 to the converter device 12. Thus, the converter device 12 can recognize the second identifier of the inverter device 14 by receiving the second identifier from the inverter device 14. Therefore, the second identifier of the inverter device 14 can be registered in the converter device 12 without forcing the operator to perform a special operation related to the pairing using an operation manual or the like. As a result, usability can be improved.

In the motor driving system 10 of the present embodiment, the inverter device 14 further includes the reading unit 34 that reads the pairing identifier from the portable apparatus 30. The communication circuit 28 transmits the pairing identifier read by the reading unit 34. Thus, the inverter device 14 can transmit the pairing identifier without forcing the operator to perform transmission operations. Further, the inverter device 14 can make the converter device 12 recognize that it is a regular pairing partner.

### Modified Example

The above-described embodiment may be modified as follows.

### Modified Example 1

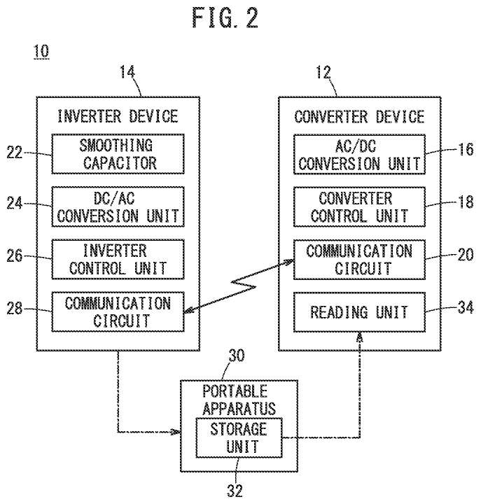

FIG. 2 is a block diagram showing a motor driving system 10 according to modified example 1. In FIG. 2, components equivalent to those described in the embodiment are denoted by the same reference numerals. In this modified example, description overlapping with that of the embodiment is omitted.

In the motor driving system 10 of the present modified example, the inverter device 14 is set as a master of pairing, and the converter device 12 is set as a slave of pairing. The storage unit 32 of the portable apparatus 30 stores a pairing identifier that is a duplicate of the first identifier held by the inverter device 14. Further, the converter device 12 is provided with the reading unit 34 that reads the pairing identifier stored in the portable apparatus 30.

When the reading unit 34 of the converter device 12 reads the pairing identifier from the portable apparatus 30, the reading unit 34 registers the pairing identifier. In this case, the communication circuit 20 of the converter device 12 uses the access information of the inverter device 14 registered in advance to transmit the second identifier held by the converter device 12 together with the pairing identifier to the inverter device 14.

When the communication circuit 28 of the inverter device 14 receives the second identifier together with the pairing identifier, the communication circuit 28 recognizes that the converter device 12 that transmitted the second identifier is a regular pairing partner and registers the second identifier. In this case, the communication circuit 28 communicates with the communication circuit 20.

As described above, the motor driving system 10 of the present modified example is provided with the portable apparatus 30 that stores the first identifier of the inverter device 14 as a pairing identifier readable for the converter device 12, the inverter device 14 serving as the slave of pairing and the converter device 12 serving as the master of pairing. Thus, by reading the pairing identifier of the portable apparatus 30, the converter device 12 can recognize the first identifier of the inverter device 14 serving as the master of pairing. Therefore, the pairing with the converter device 12 can be completed without performing a special operation for pairing up with the converter device 12 using an operation manual or the like, and as a result, usability can be improved as in the embodiment.

Further, in the motor driving system 10 of the present embodiment, the converter device 12 includes the communication circuit 20 for communicating with the inverter device 14 by wire or wirelessly. The communication circuit 20 transmits the pairing identifier and the second identifier of the converter device 12 to the inverter device 14. Thus, the inverter device 14 can recognize the second identifier of the converter device 12 by receiving the second identifier from the converter device 12. Therefore, the pairing with the inverter device 14 can be completed without requiring the operator to perform a special operation for pairing up with the inverter device 14 using an operation manual or the like, and as a result, usability can be improved.

### Modified Example 2

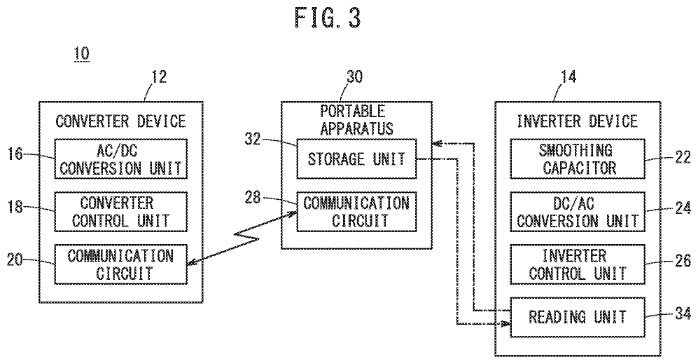

FIG. 3 is a block diagram showing a motor driving system 10 according to modified example 2. In FIG. 3, components equivalent to those described in the embodiment are denoted by the same reference numerals. In this modified example, description overlapping with that of the embodiment is omitted.

In the motor driving system 10 of the present modified example, the inverter device 14 is not provided with the communication circuit 28, but instead the portable apparatus 30 is provided with the communication circuit 28. Further, in the motor driving system 10 of the present modified example, the communication circuit 20 of the converter device 12 and the communication circuit 28 of the portable apparatus 30 are connected wirelessly. The communication circuit 20 and the communication circuit 28 wirelessly exchange information relating to pairing.

The portable apparatus 30 acquires the power of the inverter device 14 via the reading unit 34 and is activated using the acquired power. When the portable apparatus 30 is activated, it acquires the second identifier held by the inverter device 14 and sends the pairing identifier stored in the storage unit 32 to the inverter device 14 via the reading unit 34. The communication circuit 28 is activated by using the power of the inverter device 14. The communication circuit 28 transmits to the converter device 12 the second identifier acquired from the inverter device 14 and the pairing identifier stored in the storage unit 32 using access information of the inverter device 14 registered in advance.

As described above, in the motor driving system 10 of the present modified example, the communication circuit 28 provided at the portable apparatus 30 transmits the pairing identifier and the second identifier held by the inverter device 14 to the converter device 12 by using the power of the inverter device 14. Thus, the second identifier of the inverter device 14 can be transmitted to the converter device 12 together with the pairing identifier of the portable apparatus 30 without providing the communication circuit 28 at the inverter device 14. Therefore, the inverter device 14 can be reduced in size in comparison with a case where the communication circuit 28 is provided at the inverter device 14.

### Modified Example 3

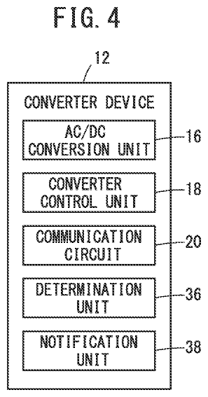

FIG. 4 is a block diagram showing a converter device 12 according to modified example 3. In FIG. 4, components equivalent to those described in the embodiment are denoted by the same reference numerals. In this modified example, description overlapping with that of the embodiment is omitted.

In the motor driving system 10 of the present modified example, the converter device 12 is newly provided with a determination unit 36 and a notification unit 38.

The determination unit 36 determines whether or not an operation failure occurs with the inverter device 14 based on operating conditions of the inverter device 14. As an operating condition, for example, an operating voltage (corresponding operating voltage) is given that can be supported by the motor connected to the inverter device 14. Another example of the operating condition is the maximum capacitance of the smoothing capacitor 22.

After the second identifier of the inverter device 14 is registered, the determination unit 36 acquires the operating conditions of the inverter device 14. The determination unit 36 may acquire, by using the communication circuit 20, the operating conditions of the inverter device 14 transmitted from the inverter device 14. Further, the determination unit 36 may acquire an operating condition of a type corresponding to the second identifier of the inverter device 14 by using a table in which the type of the inverter device 14 and the operating condition are associated with each other.

When the determination unit 36 acquires the operating condition, the determination unit 36 recognizes whether an output of the motor connected to the inverter device 14 exceeds the power that can be supplied by the converter device 12 based on the acquired operating condition. Here, when the output of the motor connected to the inverter device 14 exceeds the power that can be supplied by the converter device 12, the determination unit 36 determines that an operation failure may occur between the converter device 12 and the inverter device 14. On the other hand, when the output of the motor connected to the inverter device 14 is equal to or less than the power that can be supplied by the converter device 12, the determination unit 36 determines that an operation failure cannot occur between the converter device 12 and the inverter device 14.

When the determination unit 36 judges that an operation failure may occur, the notification unit 38 notifies that an operation failure may occur between the converter device 12 and the inverter device 14. When at least one of a display unit, a speaker, and a light emitting unit is provided at the converter device 12, the notification unit 38 may perform notification by using at least one of the display unit, the speaker, and the light emitting unit. When an external device having at least one of a display unit, a speaker, and a light emitting unit is connected to the converter device 12, the notification unit 38 may send an operation signal to an external device to give a notification.

As described above, the motor driving system 10 of the present modified example determines whether or not an operation failure can occur between the converter device 12 and the inverter device 14 based on the operating conditions of the inverter device 14. Further, when the determination that the operation failure may occur is obtained, the motor driving system 10 notifies accordingly. Thus, it is possible to prevent the converter device 12 from falling into an overload state.

### Modified Example 4

The above-described embodiments and modified examples 1 to 3 may be arbitrarily combined within a range where no contradiction occurs.

### Inventions Grasped from Embodiments and Modified Examples

The present invention is the motor driving system (10) for pairing the converter device (12) and the inverter device (14). The motor driving system is provided with the portable apparatus (30) configured to store, for pairing the converter device and the inverter device, the pairing identifier that is a duplicate of a first identifier held by one device out of the converter device and the inverter device and is readable for another device out of the converter device and the inverter device. Thus, the other device can recognize the first identifier of the one device by reading the pairing identifier of the portable apparatus. Therefore, the pairing with the other device can be completed without requiring the operator to perform a special operation for pairing up with the other device using an operation manual or the like, and as a result, usability can be improved.

The other device may include the communication circuit (20 or 28) configured to communicate with the one device by wire or wirelessly, and the communication circuit may transmit a pairing identifier and a second identifier held by the other device to the one device.

As a result, the one device can recognize the second identifier of the other device by receiving the second identifier from the other device. Accordingly, the pairing with the one device can be completed without requiring the operator to perform a special operation for pairing up with the one device using an operation manual or the like, and as a result, usability can be improved.

The portable apparatus may include a communication circuit configured to wirelessly communicate with the one device, and the communication circuit may transmit the pairing identifier and the second identifier held by the other device to the one device by using the electric power of the other device.

As a result, the one device can recognize the second identifier of the other device by receiving the second identifier from the other device. Accordingly, the pairing with the one device can be completed without requiring the operator to perform a special operation for pairing up with the one device using an operation manual or the like, and as a result, usability can be improved.

Further, in comparison with a case where the communication circuit is provided in the other device, the other device can be reduced in size.

The other device may include the reading unit (34) configured to read the pairing identifier from the portable apparatus, and the communication circuit may transmit the pairing identifier read by the reading unit.

Thus, it is possible to transmit the pairing identifier without the operator's transmission operation, and by transmitting the pairing identifier, it is possible for the one device to recognize a regular pairing partner.

The one device may include with the determination unit (36) configured to determines whether an operation failure may occur between the one device and the other device based on an operation condition of the other device, and a notification unit (38) that, when the determination unit determines that the operation failure may occur, notifies the determination.

Thus, it is possible to prevent the one device from falling into an overload state.

The operation condition may include a corresponding operating voltage of the other device or a maximum capacity of the smoothing capacitor (22) configured to smooth direct current power converted by the converter device.

1. A motor driving system for pairing a converter device and an inverter device, the motor driving system comprising:
a portable apparatus configured to store, for pairing the converter device and the inverter device, a pairing identifier that is a duplicate of a first identifier held by one device out of the converter device and the inverter device and is readable for another device out of the converter device and the inverter device.

2. The motor driving system according to claim 1, wherein
the another device includes a communication circuit configured to communicate with the one device by wire or wirelessly, and
the communication circuit transmits the pairing identifier and a second identifier held by the another device to the one device.

3. The motor driving system according to claim 1, wherein
the portable apparatus includes a communication circuit configured to wirelessly communicates with the one device, and
the communication circuit transmits the pairing identifier and a second identifier held by the another device to the one device by using electric power of the another device.

4. The motor driving system according to claim 2, wherein
the another device includes a reading unit configured to reads the pairing identifier from the portable apparatus, and
the communication circuit transmits the pairing identifier read by the reading unit.

5. The motor driving system according to claim 1, wherein
the one device includes:
a determination unit configured to determine whether an operation failure may occur between the one device and the another device based on an operation condition of the another device; and
a notification unit configured to, when the determination unit determines that the operation failure may occur, notify the determination.

6. The motor driving system according to claim 5, further comprising a smoothing capacitor configured to smooth direct current power converted by the converter device,
wherein
the operation condition includes a corresponding operating voltage of the another device or a maximum capacity of the smoothing capacitor.
